(19) United States
(12) Patent Application Publication
(10) Pub. No.: US 2025/0193808 A1
(43) Pub. Date: Jun. 12, 2025

(54) POWER HEADROOM REPORTING IN WIRELESS COMMUNICATIONS SYSTEMS

(71) Applicant: Samsung Electronics Co., Ltd., Suwon-si (KR)

(72) Inventor: Anil Agiwal, Allen, TX (US)

(21) Appl. No.: 18/942,286

(22) Filed: Nov. 8, 2024

Related U.S. Application Data
(60) Provisional application No. 63/609,173, filed on Dec. 12, 2023.
(60) Provisional application No. 63/624,618, filed on Jan. 24, 2024.
(60) Provisional application No. 63/643,676, filed on May 7, 2024.

(51) Int. Cl. H04W 52/36

(52) U.S. Cl. CPC H04W 52/365

(57) ABSTRACT

A UE includes a transceiver configured to receive a message including an index “ServCellIndex” of one or more serving cells. The UE also includes a processor operably coupled to the transceiver, configured to generate, for a power headroom (PH) report (PHR), a first bitmap that indicates presence of a PH field in the PHR for a serving cell configured with ServCellIndex i. The processor is also configured to sequentially index the one or more serving cells for which a corresponding bit in the first bitmap is set to 1 and a PCell. The processor is also configured to generate, for the PHR, a second bitmap that indicates presence of a PCMAX,f,c for assumed PUSCH field in the PHR for the sequentially indexed PCell and one or more serving cells. The transceiver is also configured to transmit, to a BS, the PHR including the first bitmap and the second bitmap.

### CROSS-REFERENCE TO RELATED APPLICATIONS AND CLAIM OF PRIORITY

This application claims priority under 35 U.S.C. § 119 (e) to U.S. Provisional Patent Application No. 63/609,173 filed on Dec. 12, 2023; U.S. Provisional Patent Application No. 63/624,618 filed on Jan. 24, 2024; and U.S. Provisional Patent Application No. 63/643,676 filed on May 7, 2024. The above-identified provisional patent applications are hereby incorporated by reference in their entirety.

### TECHNICAL FIELD

This disclosure relates generally to wireless networks. More specifically, this disclosure relates to power headroom reporting in wireless communications systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for power headroom reporting in wireless communications systems.

In one embodiment, a user equipment (UE) is provided. The UE includes a transceiver configured to receive, from a base station (BS), a message including an index “ServCellIndex” of one or more serving cells. The UE also includes a processor operably coupled to the transceiver. The processor is configured to generate, for a power headroom report (PHR), a first bitmap, wherein an i^{th} bit in the first bitmap set to 1 indicates presence of a power headroom (PH) field in the PHR for a serving cell configured with ServCellIndex i. The processor is also configured to sequentially index the one or more serving cells for which a corresponding bit in the first bitmap is set to land a primary serving cell (PCell), starting with the PCell and followed by the one or more serving cells in ascending order of ServCellIndex. The processor is also configured to generate, for the PHR, a second bitmap, wherein a kth bit in the second bitmap indicates presence of a PCMAX,f,c for assumed PUSCH field in the PHR for a kth serving cell amongst the sequentially indexed PCell and one or more serving cells. The transceiver is also configured to transmit, to the BS, the PHR including the first bitmap and the second bitmap.

In another embodiment, a BS is provided. The BS includes a processor, and a transceiver operatively coupled to the processor. The transceiver is configured to transmit, to a UE, a message including an index “ServCellIndex” of one or more serving cells, and receive, from the UE, a PHR. The PHR includes a first bitmap, wherein an i^{th} bit in the first bitmap set to 1 indicates presence of a PH field in the PHR for a serving cell configured with ServCellIndex i. The PHR also includes a second bitmap, wherein a kth bit in the second bitmap indicates presence of a P_{CMAX.f.c} for assumed PUSCH field in the PHR for a kth serving cell amongst a PCell and the one or more serving cells for which a corresponding bit in the first bitmap is set to 1, the PCell and the one or more serving cells sequentially indexed starting with the PCell and followed by the one or more serving cells in ascending order of ServCellIndex.

In yet another embodiment, a method of operating a UE is provided. The method includes receiving, from a BS, a message including an index “ServCellIndex” of one or more serving cells, and generating, for a PHR, a first bitmap, wherein an i^{th} bit in the first bitmap set to 1 indicates presence of a power headroom (PH) field in the PHR for a serving cell configured with ServCellIndex i. The method also includes sequentially indexing the one or more serving cells for which a corresponding bit in the first bitmap is set to 1 and a PCell, starting with the PCell and followed by the one or more serving cells in ascending order of ServCellIndex, and generating, for the PHR, a second bitmap, wherein a kth bit in the second bitmap indicates presence of a P_{CMAX,f,c} for assumed PUSCH field in the PHR for a kth serving cell amongst the sequentially indexed PCell and one or more serving cells. The method also includes transmitting, to the BS, the PHR including the first bitmap and the second bitmap.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIGS. 4A-4B illustrate an example PHR MAC CE format according to embodiments of the present disclosure;

FIG. 5 illustrates an example method for power headroom reporting according to embodiments of the present disclosure;

FIGS. 6A-6D illustrate example bitmaps for a PHR MAC CE format according to embodiments of the present disclosure;

FIG. 7 illustrates another example method for power headroom reporting according to embodiments of the present disclosure;

FIGS. 8A-8D illustrate example bitmaps for a PHR MAC CE format according to embodiments of the present disclosure; and

FIG. 9 illustrates another example method for power headroom reporting according to embodiments of the present disclosure.

### DETAILED DESCRIPTION

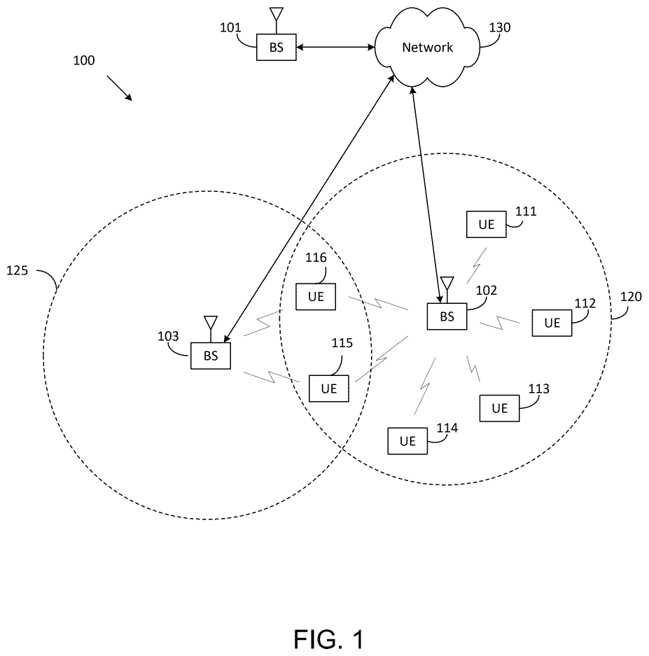

FIGS. 1 through 9, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for power headroom reporting. In certain embodiments, one or more of the gNBs 101-103 includes circuitry, programing, or a combination thereof, to support power headroom reporting in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

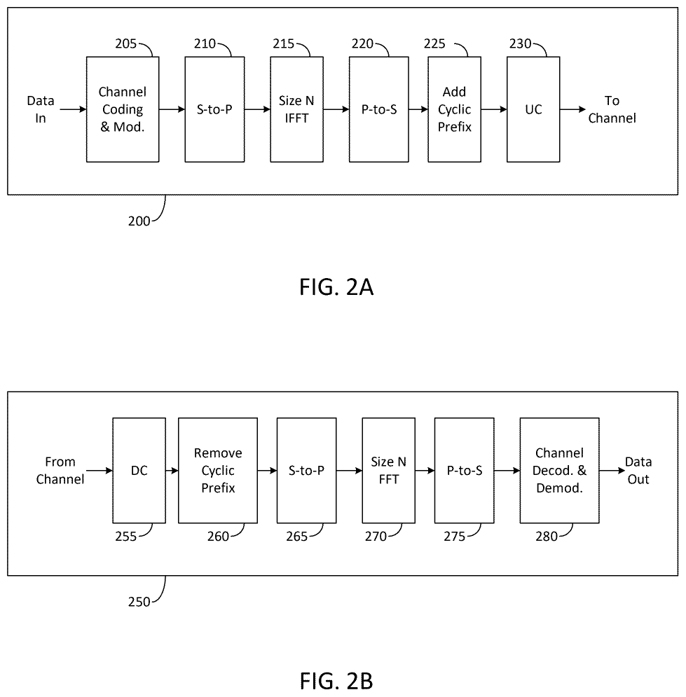

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support power headroom reporting as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

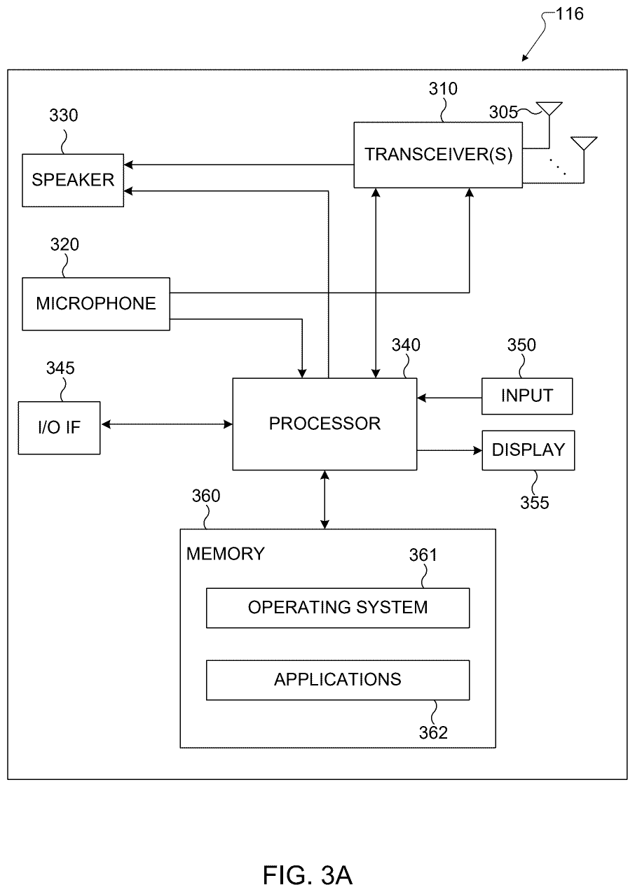

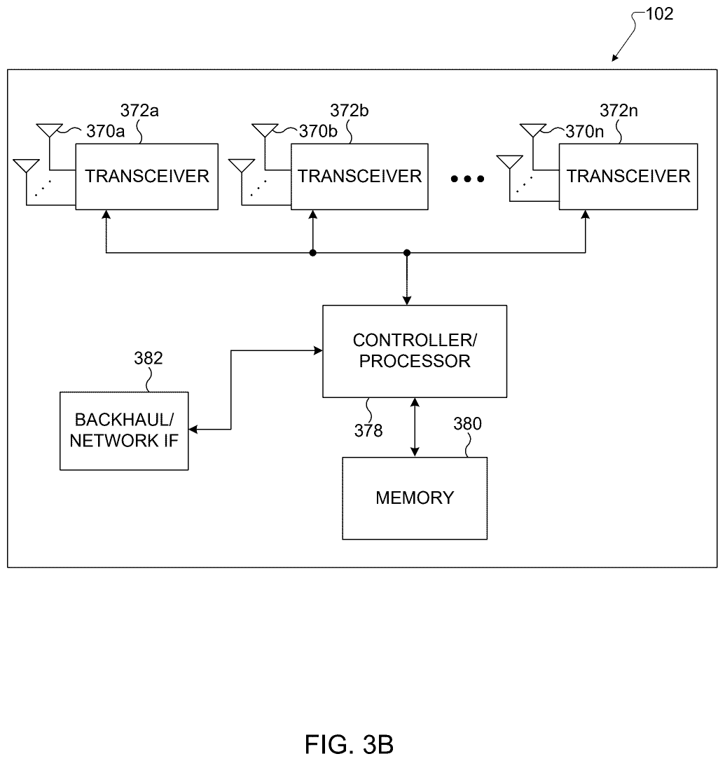

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for power headroom reporting as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support power headroom reporting as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports standalone modes of operation as well dual connectivity (DC). In DC a multiple RX/TX UE may be configured to utilize resources provided by two different nodes (or NBs) connected via a non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells. In NR the term Master Cell Group (MCG) refers to a group of serving cells (SCells) associated with the Master Node, comprising the primary cell (PCell) and optionally one or more SCells. In NR the term Secondary Cell Group (SCG) refers to a group of serving cells associated with the Secondary Node, comprising the Primary SCG Cell (PSCell) and optionally one or more SCells. In NR, PCell refers to a serving cell in MCG, operating on the primary frequency, in which the UE either performs the initial connection establishment procedure or initiates the connection re-establishment procedure. In NR for a UE configured with CA, an Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell refers to the PCell of the MCG or the PSCell of the SCG, otherwise the term Special Cell refers to the PCell.

In the next generation wireless communication system (e.g., 5G, beyond 5G, 6G), the Physical Downlink Control Channel (PDCCH) is used to schedule DL transmissions on the Physical Downlink Shared Channel (PDSCH) and UL transmissions on the Physical Uplink Shared Channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mapping is supported in a CORESET. Polar coding is used for the PDCCH. Each resource element group carrying the PDCCH carries its own DMRS. QPSK modulation is used for the PDCCH.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH on the one active BWP instead of on the entire DL frequency of the serving cell. In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular time. BWP switching is controlled by the PDCCH indicating a downlink assignment or an uplink grant, by the bwp-Inactivity Timer, by RRC signalling, or by the MAC entity itself upon initiation of a Random-Access procedure. Upon addition of an SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or a PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), a power headroom reporting procedure is used to provide the serving gNB with the following information:
Type 1 power headroom: the difference between the nominal UE maximum transmit power and the estimated power for UL-SCH transmission per activated Serving Cell;
Type 2 power headroom: the difference between the nominal UE maximum transmit power and the estimated power for UL-SCH and PUCCH transmission on SpCell of the other MAC entity (i.e., E-UTRA MAC entity in EN-DC, NE-DC, and NGEN-DC cases);
Type 3 power headroom: the difference between the nominal UE maximum transmit power and the estimated power for SRS transmission per activated Serving Cell;
MPE P-MPR: the power backoff to meet the MPE FR2 requirements for a Serving Cell operating on FR2;
DPC: the adjustment to maximum output power for a given power class for a Serving Cell operating on FR1;
DPC_{BC}: the adjustment to maximum output power for a given power class for a Band Combination operating on FR1.

RRC controls Power Headroom reporting by configuring the following parameters: dpc-Reporting-FR1; phr-AssumedPUSCH-Reporting; phr-PeriodicTimer; phr-ProhibitTimer; phr-Tx-PowerFactorChange; phr-Type2OtherCell; phr-ModeOtherCG; multiplePHR; mpe-Reporting-FR2; mpe-ProhibitTimer; mpe-Threshold; numberOfN; mpe-ResourcePoolToAddModList; twoPHRMode.

A Power Headroom Report (PHR) shall be triggered if any of the following events occur:
phr-ProhibitTimer expires or has expired and the path loss has changed more than phr-Tx-PowerFactorChange dB for at least one reference signal (RS) used as a pathloss reference for one activated Serving Cell of any MAC entity of which the active DL BWP is not a dormant BWP since the last transmission of a PHR in this MAC entity when the MAC entity has UL resources for new transmission;
phr-PeriodicTimer expires;
upon configuration or reconfiguration of the power headroom reporting functionality by upper layers, which is not used to disable the function;
activation of an SCell of any MAC entity with configured uplink of which firstActiveDownlinkBWP-Id is not set to dormant BWP;
activation of an SCG;
addition of the PSCell except if the SCG is deactivated (i.e., the PSCell is newly added or changed);
phr-ProhibitTimer expires or has expired, when the MAC entity has UL resources for a new transmission, and the following is true for any of the activated Serving Cells of any MAC entity with configured uplink:
   there are UL resources allocated for transmission or there is a PUCCH transmission on this cell, and the required power backoff due to power management for this cell has changed more than phr-Tx-PowerFactorChange dB since the last transmission of a PHR when the MAC entity had UL resources allocated for transmission or PUCCH transmission on this cell.
Upon switching of an activated BWP from a dormant BWP to a non-dormant DL BWP of an SCell of any MAC entity with a configured uplink;
if dpc-Reporting-FR1 is configured, ΔP_{PowerClass}/ΔP_{PowerClass, CA}/ΔP_{PowerClass, EN-DC}/ΔP_{PowerClass, NR-DC} reporting is triggered upon uplink duty cycle exceedance or upon return to the power class after the duty cycle exceedance.
if mpe-Reporting-FR2 is configured, and mpe-ProhibitTimer is not running:
   the measured P-MPR applied to meet FR2 MPE requirements is equal to or larger than mpe-Threshold for at least one activated FR2 Serving Cell since the last transmission of a PHR in this MAC entity; or
   the measured P-MPR applied to meet FR2 MPE requirements has changed more than phr-Tx-PowerFactorChange dB for at least one activated FR2 Serving Cell since the last transmission of a PHR due to the measured P-MPR applied to meet MPE requirements being equal to or larger than mpe-Threshold in this MAC entity.
in which case the PHR is referred below to as ‘MPE P-MPR report’.

If the MAC entity (note that MAC entity is per cell group: MCG, SCG) in the UE has UL resources allocated for a new transmission the MAC entity shall:
if it is the first UL resource allocated for a new transmission since the last MAC reset, start phr-Periodic Timer;
if the Power Headroom reporting procedure determines that at least one PHR has been triggered and not cancelled; and
if the allocated UL resources can accommodate the MAC CE for PHR which the MAC entity is configured to transmit, plus its subheader, as a result of LCP:
   if multiplePHR with value true is configured, instruct the Multiplexing and Assembly procedure to generate and transmit the multiple entry PHR MAC CE. Otherwise, (i.e., Single Entry PHR format is used): instruct the Multiplexing and Assembly procedure to generate and transmit the Single entry PHR MAC CE;
   start or restart phr-PeriodicTimer;
   start or restart phr-ProhibitTimer; and
   cancel all triggered PHR(s).

The PHAR MAC CE includes the power head room level (PH), P_{CMAX,f,c} used for calculation of PH.

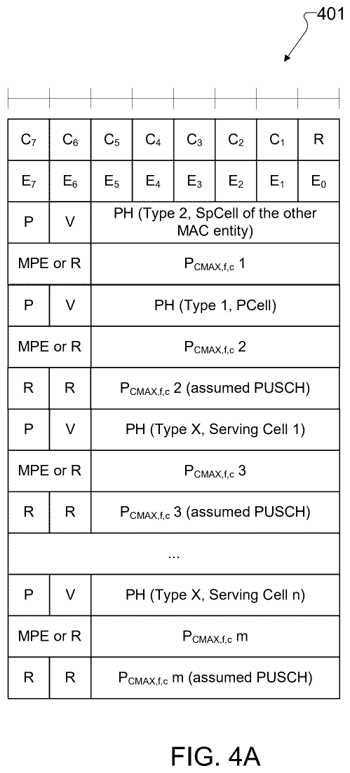

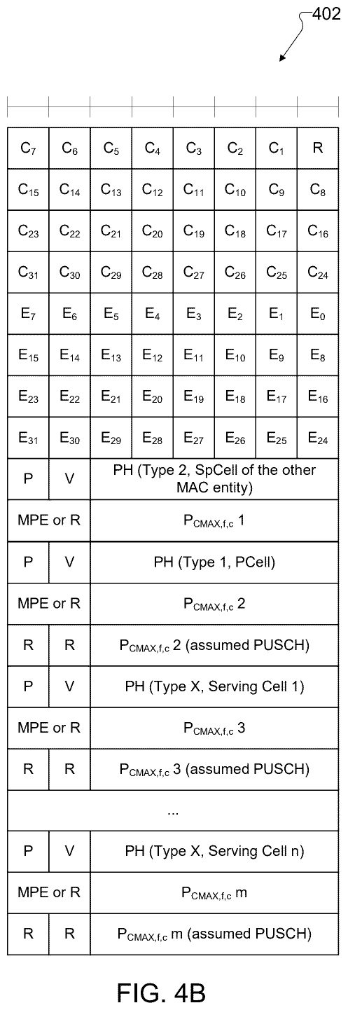

Dynamic waveform switching is supported in the next generation wireless communication system (e.g., 5G, beyond 5G, 6G). In order to assist the scheduler in determining waveform switching, the UE reports power headroom information for an assumed PUSCH using a target waveform different from the waveform of the actual PUSCH. The waveform can be a DFT-S-OFDM (Discrete Fourier Transform-Spread-Orthogonal Frequency Division Multiplexing) waveform or a CP-OFDM (Cyclic Prefix-Orthogonal Frequency Division Multiplexing) waveform. If the actual PUSCH transmission is with a DFT-S-OFDM waveform, the UE computes power headroom information of an assumed PUSCH with a CP-OFDM waveform. If the actual PUSCH transmission is with a CP-OFDM waveform, the UE computes power headroom information of an assumed PUSCH with a DFT-S-OFDM waveform. Power headroom information for an assumed PUSCH contains: P_{CMAX,f,c} of the assumed PUSCH. P_{CMAX,f,c} is the UE configured maximum output power for carrier f of serving cell c. All parameters that are used for the calculation of P_{CMAX,f,c}, except waveform, are the same between the assumed PUSCH and the actual PUSCH. The PHR MAC CE format also referred to as ‘Multiple Entry PHR with assumed PUSCH MAC CE’ for reporting assumed PUSCH for serving cell(s) is shown in FIG. 4A and FIG. 4B.

FIGS. 4A-4B illustrate an example PHR MAC CE format 400 according to embodiments of the present disclosure. The embodiment of a PHR MAC CE format of FIGS. 4A-4B is for illustration only. Different embodiments of a PHR MAC CE format could be used without departing from the scope of this disclosure.

PHR MAC CE format 400 (which may also be referred to as Multiple Entry PHR with assumed PUSCH MAC CE 400) can be identified by a MAC subheader with extended Logical Channel ID (eLCID).

PHR MAC CE format 400 has a variable size, and includes a bitmap, a Type 2 PH field, an octet containing the associated P_{CMAX,f,c} field (if reported) and an octet containing the associated P_{CMAX,f,c} field for the assumed PUSCH (if reported) for the SpCell of the other MAC entity; a Type 1 PH field, an octet containing the associated P_{CMAX,f,c} field (if reported) and an octet containing the associated P_{CMAX,f,c} field for the assumed PUSCH (if reported) for the PCell. PHR MAC CE format 400 further includes, in ascending order based on the ServCellIndex, one or multiple of Type X PH fields, octets containing the associated P_{CMAX,f,c} fields (if reported) and octets containing the associated P_{CMAX,f,c} fields for the assumed PUSCH (if reported) for Serving Cells other than the PCell indicated in the bitmap. X is either 1 or 3.

The presence of a Type 2 PH field for the SpCell of the other MAC entity is configured by phr-Type 2OtherCell with value true.

A single octet bitmap is used for indicating the presence of the PH per Serving Cell when the highest ServCellIndex of Serving Cell with configured uplink is less than 8 (shown in FIG. 4A), otherwise four octets are used (shown in FIG. 4B). For a serving cell which is a PCell, ServCellIndex is 0. For a serving cell which is a PSCell or SCell, ServCellIndex (also referred as SCellIndex) is received in the RRCReconfiguration message from the gNB.

The MAC entity determines whether the PH value for an activated Serving Cell is based on a real transmission or a reference format by considering the configured grant(s) and downlink control information which has been received until and including the PDCCH occasion in which the first UL grant for a new transmission that can accommodate the MAC CE for PHR as a result of LCP is received since a PHR has been triggered if the PHR MAC CE is reported on an uplink grant received on the PDCCH or until the first uplink symbol of PUSCH transmission minus PUSCH preparation time if the PHR MAC CE is reported on a configured grant.

For a band combination in which the UE does not support dynamic power sharing, the UE may omit the octets containing Power Headroom field and P_{CMAX,f,c} field for Serving Cells in the other MAC entity except for the PCell in the other MAC entity and the reported values of Power Headroom and P_{CMAX,f,c} for the PCell are up to UE implementation.

The PHR MAC CEs are defined as follows:
Cᵢ: This field indicates the presence of a PH field for the Serving Cell with ServCellIndex i. The Cᵢ field set to 1 indicates that a PH field for the Serving Cell with ServCellIndex i is reported. The Cᵢ field set to 0 indicates that a PH field for the Serving Cell with ServCellIndex i is not reported;
Eᵢ: This field indicates the presence of a P_{CMAX,f,c} for assumed PUSCH field for the Serving Cell with ServCellIndex i. The Eᵢ field set to 1 indicates that a P_{CMAX,f,c} for assumed PUSCH field for the Serving Cell with ServCellIndex i is reported. The Eᵢ field set to 0 indicates that a P_{CMAX,f,c} for assumed PUSCH field for the Serving Cell with ServCellIndex i is not reported. For the E-UTRA Serving Cell, the corresponding Eᵢ field is set to 0;
R: Reserved bit, set to 0;
V: This field indicates if the PH value is based on a real transmission or a reference format. For Type 1 PH, the V field set to 0 indicates real transmission on PUSCH and the V field set to 1 indicates that a PUSCH reference format is used. For Type 2 PH, the V field set to 0 indicates real transmission on PUCCH and the V field set to 1 indicates that a PUCCH reference format is used. For Type 3 PH, the V field set to 0 indicates real transmission on SRS and the V field set to 1 indicates that an SRS reference format is used. Furthermore, for Type 1, Type 2, and Type 3 PH, the V field set to 0 indicates the presence of the octet containing the associated P_{CMAX,f,c} field and the MPE field, and the V field set to 1 indicates that the octet containing the associated P_{CMAX,f,c} field and the MPE field is omitted;
Power Headroom (PH): This field indicates the power headroom level.
P: If mpe-Reporting-FR2 is configured and the Serving Cell operates on FR2, the MAC entity shall set this field to 0 if the applied P-MPR value, to meet MPE requirements, is less than P-MPR_00 and to 1 otherwise. If mpe-Reporting-FR2 is not configured or the Serving Cell operates on FR1, this field indicates whether power backoff is applied due to power management. The MAC entity shall set the P field to 1 if the corresponding P_{CMAX,f,c} field would have had a different value if no power backoff due to power management had been applied;
P_{CMAX,f,c}: If present, this field indicates the P_{CMAX,f,c} for the NR Serving Cell and the P_{CMAX,c} or \tilde{P}_{CMAX,c} for the E-UTRA Serving Cell used for calculation of the preceding PH field.
P_{CMAX,f,c} for assumed PUSCH: If present, this field indicates the P_{CMAX,f,c} for assumed PUSCH for the NR Serving Cell.
MPE: If mpe-Reporting-FR2 is configured, and the Serving Cell operates on FR2, and if the P field is set to 1, this field indicates the applied power backoff to meet MPE requirements. If mpe-Reporting-FR2 is not configured, or if the Serving Cell operates on FR1, or if the P field is set to 0, R bits are present instead.

Although FIGS. 4A-4B illustrates an example PHR MAC CE format 400, various changes may be made to FIGS. 4A-4B. For example, various changes to the size of the bitmaps, etc. could be made according to particular needs.

According to the design of the Multiple Entry PHR with assumed PUSCH MAC CE of FIGS. 4A-4B, 4 octets for Ei are always included if the highest ServCellIndex of Serving Cell with configured uplink is equal to or higher than 8, even if many of the serving cells are not configured to support dynamic waveform switching and/or for which PH is not reported in the MAC CE (i.e., assumed PUSCH is not reported for these). For example, if only a Serving Cell with ServCellIndex 8 is configured with uplink and support dynamic waveform switching, 4 octets of Ei are always included in multiple Entry PHR with assumed PUSCH MAC CE. Various embodiments of the present disclosure provide enhancements to the Multiple Entry PHR with assumed PUSCH MAC CE to reduce this overhead.

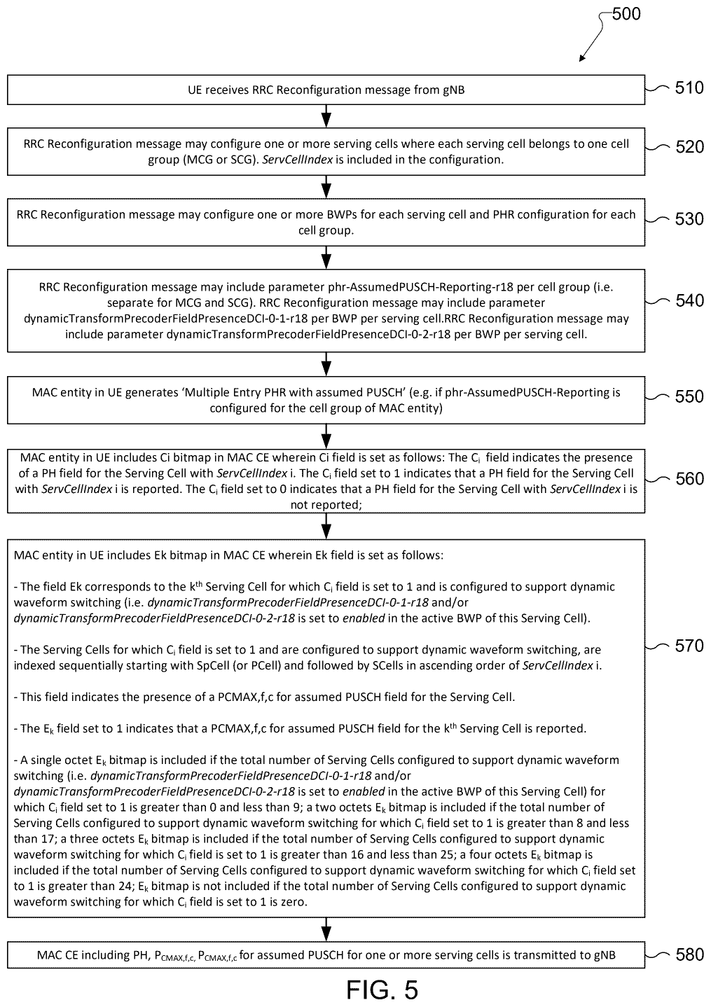

FIG. 5 illustrates an example method for PHR reporting 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments or a method for PHR reporting could be used without departing from the scope of this disclosure.

In the example of FIG. 5, method 500 begins at step 510. At step 510, a UE such as UE 116 of FIG. 1 is in an RRC_CONNECTED state, and receives an RRC Reconfiguration message from a gNB such as BS 102 of FIG. 1.

At step 520, the RRC Reconfiguration message may configure one or more serving cells, where each serving cell belongs to one cell group (MCG or SCG). An index “ServCellIndex” is included in the configuration of the serving cell. ServCellIndex concerns a short identity, used to uniquely identify a serving cell (i.e., the PCell, the PSCell or an SCell) across the cell groups. In some embodiments, the index value 0 is applied for the PCell.

At step 530, RRC Reconfiguration message may configure one or more BWPs for each serving cell. In some embodiments, the RRC Reconfiguration message may include a PHR configuration for each cell group. In some embodiments, the PHR configuration may include one or more parameters to control the PHR operation as described herein.

At step 540, in some embodiments the RRC Reconfiguration message may include a parameter phr-AssumedPUSCH-Reporting-r18 per cell group (i.e., separate for a MCG and SCG). The parameter phr-AssumedPUSCH-Reporting-r18, if included for a cell group, is set to enabled. The absence of this parameter indicates that phr-AssumedPUSCH-Reporting-r18 is disabled.

In some embodiments, the RRC Reconfiguration message may include a parameter dynamicTransformPrecoderFieldPresenceDCI-0-1-r18 per BWP per serving cell. The parameter dynamicTransformPrecoderFieldPresenceDCI-0-1-r18, if included for a BWP of a serving cell is set to enabled. The absence of this parameter indicates that dynamicTransformPrecoderFieldPresenceDCI-0-1-r18 is disabled. If this parameter is configured, then the “Dynamic Transform Precoder” field is present in DCI format 0_1. Otherwise, the field size is set to 0 for DCI format 0_1.

In some embodiments, the RRC Reconfiguration message may include a parameter dynamicTransformPrecoderFieldPresenceDCI-0-2-r18 per BWP per serving cell. The parameter dynamicTransformPrecoderFieldPresenceDCI-0-2-r18, if included for a BWP of a serving cell is set to enabled. The absence of this parameter indicates that dynamicTransformPrecoderFieldPresenceDCI-0-2-r18 is disabled. If this parameter is configured, then the “Dynamic Transform Precoder” field is present in DCI format 0_2. Otherwise, the field size is set to 0 for DCI format 0_2.

At step 550, a PHR is triggered based on one of the trigger(s) in the MAC entity of UE. In response to the trigger, the MAC entity generates ‘Multiple Entry PHR with assumed PUSCH’ MAC CE. In some embodiments, the format of the MAC CE may be as shown in FIGS. 4A-4B. The Multiple Entry PHR with assumed PUSCH MAC CE is identified by a MAC subheader with eLCID. In the example of FIG. 5, the Multiple Entry PHR with assumed PUSCH MAC CE has a variable size, and includes the Ci bitmap, a Type 2 PH field, an octet containing the associated P_{CMAX,f,c} field (if reported) for a SpCell of the other MAC entity; a Type 1 PH field, an octet containing the associated P_{CMAX,f,c} field (if reported) and an octet containing the associated P_{CMAX,f,c} field for assumed PUSCH (if reported) for the PCell. In the example of FIG. 5, the Multiple Entry PHR with assumed PUSCH MAC CE further includes, in ascending order based on the ServCellIndex, one or multiple of Type X PH fields, octets containing the associated P_{CMAX,f,c} fields (if reported) and octets containing the associated P_{CMAX,f,c} fields for assumed PUSCH (if reported) for Serving Cells other than PCell indicated in the Cᵢ bitmap. X is either 1 or 3. The Ek bitmap indicates the presence of P_{CMAX,f,c} fields for assumed PUSCH for Serving cells. The presence of a type 2 PH field for a SpCell of the other MAC entity is configured by phr-Type 2OtherCell with value true. The MAC entity determines whether the PH value for an activated Serving Cell is based on real transmission or a reference format by considering the configured grant(s) and downlink control information which has been received until and including the PDCCH occasion in which the first UL grant for a new transmission that can accommodate the MAC CE for PHR as a result of LCP is received since a PHR has been triggered if the PHR MAC CE is reported on an uplink grant received on the PDCCH or until the first uplink symbol of PUSCH transmission minus PUSCH preparation time if the PHR MAC CE is reported on a configured grant. For a band combination in which the UE does not support dynamic power sharing, the UE may omit the octets containing Power Headroom field and P_{CMAX,f,c} field for Serving Cells in the other MAC entity except for the PCell in the other MAC entity and the reported values of Power Headroom and P_{CMAX,f,c} for the PCell are up to UE implementation.

At step 560, the MAC entity in the UE includes a Cᵢ bitmap in the MAC CE wherein the Cᵢ field is set as follows: The Cᵢ field set to 1 indicates that a PH field for the Serving Cell with ServCellIndex i is reported. The Cᵢ field set to 0 indicates that a PH field for the Serving Cell with ServCellIndex i is not reported. A single octet bitmap is used for indicating the presence of

PH per Serving Cell when the highest ServCellIndex of Serving Cell with configured uplink is less than 8, otherwise four octets are used. For example, assume there are four SCells with ServCellIndex 2, 4, 6, 9 and configured with uplink. In this example, a four octet Cᵢ bitmap is included, as the highest ServCellIndex of a serving cell configured with uplink is greater than 8. PH is included in the MAC CE for these four SCells and the PCell, so bits C₂, C₄, C₆ and C₉ in the bitmap are set to 1.

At step 570, the MAC entity in the UE includes an Eₖ bitmap in the MAC CE wherein the Eₖ field is set as follows:

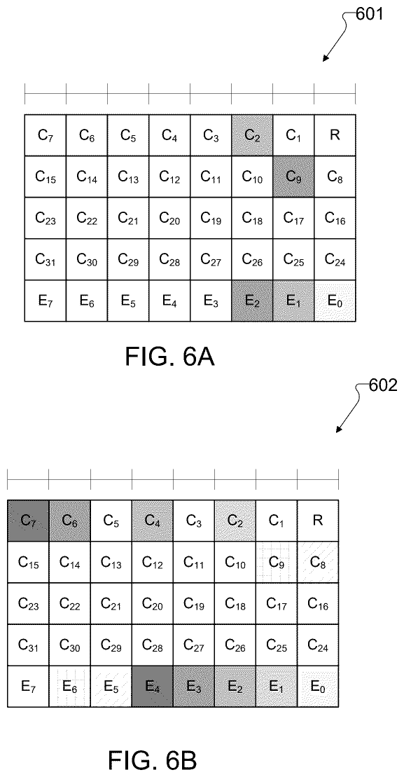

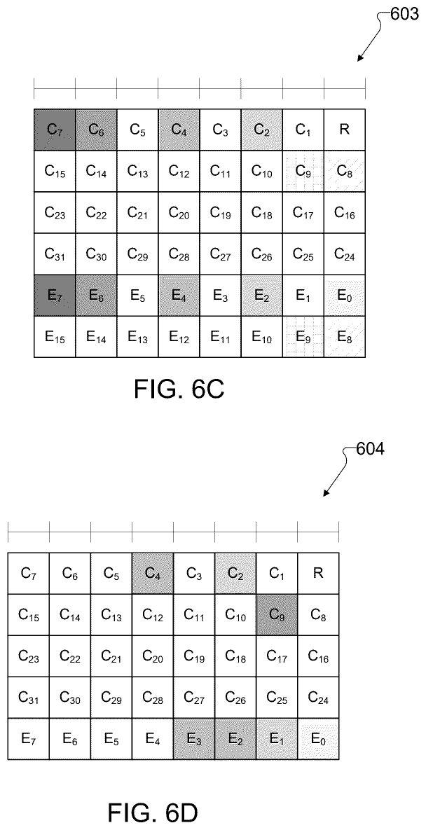

In some embodiments, the Eₖ field corresponds to the kth Serving Cell for which a Cᵢ field is set to 1 and is configured to support dynamic waveform switching (i.e., dynamicTransformPrecoderFieldPresenceDCI-0-1-r18 and/or dynamicTransformPrecoderFieldPresenceDCI-0-2-r18 is set to enabled in the active BWP of this Serving Cell). The Serving Cells for which a Cᵢ field is set to 1 and are configured to support dynamic waveform switching, are indexed sequentially starting with the SpCell (or PCell) and followed by SCells in ascending order of ServCellIndex i. In these embodiments, the Ek field indicates the presence of a P_{CMAX,f,c} for assumed PUSCH field for the kth Serving Cell amongst the indexed Serving Cells. The Eₖ field set to 1 indicates that a P_{CMAX,f,c} for assumed PUSCH field for the kth Serving Cell is reported. A single octet Ek bitmap is included if the total number of Serving Cells configured to support dynamic waveform switching (i.e., dynamicTransformPrecoderFieldPresenceDCI-0-1-r18 and/or dynamicTransformPrecoderFieldPresenceDCI-0-2-r18 is set to enabled in the active BWP of this Serving Cell) for which a Cᵢ field is set to 1 and the PCell is greater than 0 and less than 9. A two octet Eₖ bitmap is included if the total number of Serving Cells configured to support dynamic waveform switching for which a Cᵢ field is set to 1 and the PCell is greater than 8 and less than 17. A three octet Eₖ bitmap is included if the total number of Serving Cells configured to support dynamic waveform switching for which a Cᵢ field is set to 1 and the PCell is greater than 16 and less than 25. A four octet Eₖ bitmap is included if the total number of Serving Cells configured to support dynamic waveform switching for which a Cᵢ field is set to 1 and the PCell is greater than 24. The Eₖ bitmap is not included if the total number of Serving Cells configured to support dynamic waveform switching for which a Cᵢ field is set to 1 is zero. For example, assume that assumed dynamic waveform switching amongst the serving cells for which PH is included (i.e., a Cᵢ bit is set to 1) is supported for the PCell and serving cells with ServCellIndex 2 and 9. In this example, as shown in FIG. 6A, a single octet Eₖ bitmap is included as the total number of Serving Cells configured to support dynamic waveform switching (i.e., dynamicTransformPrecoderFieldPresenceDCI-0-1-r18 and/or dynamicTransformPrecoderFieldPresenceDCI-0-2-r18 is set to enabled in the active BWP of this Serving Cell) for which a Cᵢ field is set to 1 and the PCell is greater than 0 and less than 9. E₀ corresponds to the PCell, E₁ corresponds to Serving cell with ServCellIndex 2, and E₂ corresponds to Serving cell with ServCellIndex 9.

FIGS. 6A-6D illustrate example bitmaps 601-604 for a PHR MAC CE format according to embodiments of the present disclosure. The embodiment of bitmaps for a PHR MAC CE format of FIGS. 6A-6D are for illustration only. Different embodiments of bitmaps for a PHR MAC CE format could be used without departing from the scope of this disclosure.

Although FIGS. 6A-6D illustrate example bitmaps 601-604 for a PHR MAC CE format, various changes may be made to FIGS. 6A-6D. For example, various changes to the size of the bitmaps, etc. could be made according to particular needs.

In some other embodiments, the Eₖ field corresponds to the kth Serving Cell which is configured to support dynamic waveform switching (i.e., dynamicTransformPrecoderFieldPresenceDCI-0-1-r18 and/or dynamicTransformPrecoderFieldPresenceDCI-0-2-r18 is set to enabled in the active BWP of this Serving Cell). The Serving Cells which are configured to support dynamic waveform switching, are indexed sequentially starting with SpCell (or PCell) and followed by SCells in ascending order of ServCellIndex i. In these embodiments, the Eₖ field indicates the presence of a P_{CMAX,f,c} for assumed PUSCH field for the k^{th} Serving Cell amongst the indexed serving cells. The Eₖ field set to 1 indicates that a P_{CMAX,f,c} for assumed PUSCH field for the k^{th} Serving Cell is reported. A single octet Eₖ bitmap is included if the total number of Serving Cells configured to support dynamic waveform switching (i.e., dynamicTransformPrecoderFieldPresenceDCI-0-1-r18 and/or dynamicTransformPrecoderFieldPresenceDCI-0-2-r18 is set to enabled in the active BWP of this Serving Cell) and the PCell is greater than 0 and less than 9. A two octet Eₖ bitmap is included if the total number of Serving Cells configured to support dynamic waveform switching is greater than 8 and less than 17. A three octet Eₖ bitmap is included if the total number of Serving Cells configured to support dynamic waveform switching is greater than 16 and less than 25. A four octet Eₖ bitmap is included if the total number of Serving Cells configured to support dynamic waveform switching is greater than 24. the Eₖ bitmap is not included if the total number of Serving Cells configured to support dynamic waveform switching is zero. For example, assume that assumed dynamic waveform switching is supported for PCell and serving cells with ServCellIndex 2, 4, 6, 7, 8, and 9. In this example, as shown in FIG. 6B, a single octet Eₖ bitmap is included, as the total number of Serving Cells configured to support dynamic waveform switching (i.e., dynamicTransformPrecoderFieldPresenceDCI-0-1-r18 and/or dynamicTransformPrecoderFieldPresenceDCI-0-2-r18 is set to enabled in the active BWP of this Serving Cell) is greater than 0 and less than 9. E₀ corresponds to the PCell, E₁ corresponds to the Serving cell with ServCellIndex 2, E₂ corresponds to the Serving cell with ServCellIndex 4, E₃ corresponds to the Serving cell with ServCellIndex 6, E₄ corresponds to the Serving cell with ServCellIndex 7, E₅ corresponds to the Serving cell with ServCellIndex 8 and E₆ corresponds to the Serving cell with ServCellIndex 9.

In some other embodiments, the Eₖ field indicates the presence of a P_{CMAX,f,c} for assumed PUSCH field for the Serving Cell with ServCellIndex k. The Eₖ field set to 1 indicates that a P_{CMAX,f,c} for assumed PUSCH field for the Serving Cell with ServCellIndex k is reported. The Eₖ field set to 0 indicates that a P_{CMAX,f,c} for assumed PUSCH field for the Serving Cell with ServCellIndex k is not reported. For the E-UTRA Serving Cell, the corresponding Eₖ field is set to 0. A single octet Eₖ bitmap is included if the highest ServCellIndex i for which Cᵢ is set to 1 is greater than 0 and less than 8. A two octet Eₖ bitmap is included if the highest ServCellIndex i for which Cᵢ is set to 1 is greater than 7 and less than 16. A three octet Eₖ bitmap is included if the highest ServCellIndex i for which Cᵢ is set to 1 is greater than 15 and less than 24. A four octet Eₖ bitmap is included if the highest ServCellIndex i for which Cᵢ is set to 1 is greater than 23. For example, assume Cᵢ is set to 1 for the serving cells with ServCellIndex 2, 4, 6, 7, 8, and 9. In this example as, shown in FIG. 6C, a two octet Eₖ bitmap is included, as the highest ServCellIndex i for which Cᵢ is set to 1 is 9 (i.e., greater than 8 and less than 17). E₀ corresponds to the PCell, E₂ corresponds to the Serving cell with ServCellIndex 2, E₄ corresponds to the Serving cell with ServCellIndex 4, E₆ corresponds to the Serving cell with ServCellIndex 6, E₈ corresponds to the Serving cell with ServCellIndex 8, and E₉ corresponds to the Serving cell with ServCellIndex 9.

In some other embodiments, a two octet Eₖ bitmap is included if the total number of Serving Cells for which a Cᵢ field is set to 1 is greater than 7 and less than 16. A three octet Eₖ bitmap is included if the total number of Serving Cells for which a Cᵢ field is set to 1 is greater than 15 and less than 24. A four octet Eₖ bitmap is included if the total number of Serving Cells for which a Cᵢ field is set to 1 is greater than 23. Otherwise, a one octet Eₖ bitmap is included. In these embodiments, the Eₖ field indicates the presence of a P_{CMAX,f,c} for assumed PUSCH field for the k^{th} Serving Cell (or SCell) for which a Cᵢ field is set to 1. The Serving Cells (SCells) for which a Cᵢ field is set to 1 are indexed sequentially in ascending order of ServCellIndex. The Eₖ field set to 1 indicates that a P_{CMAX,f,c} for assumed PUSCH field for the k^{th} Serving Cell (SCell) is reported. The Eₖ field set to 0 indicates that a P_{CMAX,f,c} for assumed PUSCH field for the k^{th} Serving Cell (or SCell) is not reported. For the E-UTRA Serving Cell, the corresponding Eₖ field is set to 0. E₀ set to 1 indicates that the P_{CMAX,f,c} for assumed PUSCH field for the PCell is reported. E₀ set to 0 indicates that the P_{CMAX,f,c} for assumed PUSCH field for the PCell is not reported. E0 corresponds to the PCell.

In some other embodiments, a single octet Eₖ bitmap is included if the total number of Serving Cells (i.e., SCells/Serving Cells for which a Cᵢ field is set to 1 and the PCell) is greater than 0 and less than 9. A two octet Eₖ bitmap is included if the total number of Serving Cells (i.e., SCells/Serving Cells for which a Cᵢ field is set to 1 and the PCell) is greater than 8 and less than 17. A three octet Eₖ bitmap is included if the total number of Serving Cells (i.e., SCells/Serving Cells for which a Cᵢ field is set to 1 and the PCell) is greater than 16 and less than 25. A four octet Eₖ bitmap is included if the total number of Serving Cells (i.e., SCells/Serving Cells for which a Cᵢ field is set to 1 and the PCell) is greater than 24. In some embodiments, at least one octet bitmap is included for any total number of serving cells. In these embodiments, the Eₖ field indicates the presence of a P_{CMAX,f,c} for assumed PUSCH field for the k^{th} Serving Cell for which a Cᵢ field is set to 1. The Serving Cells (i.e., SCells/Serving Cells for a which Cᵢ field is set to 1 and the PCell) are indexed sequentially starting with the PCell and followed by the other serving cells in ascending order of ServCellIndex i. The Eₖ field set to 1 indicates that a P_{CMAX,f,c} for assumed PUSCH field for the k^{th} Serving Cell (i.e. the k^{th} Serving Cell amongst the indexed serving cells) is reported. The Eₖ field set to 0 indicates that a P_{CMAX,f,c} for assumed PUSCH field for the k^{th} Serving Cell is not reported. For the E-UTRA Serving Cell, the corresponding Eₖ field is set to 0. For example, assume Cᵢ is set to 1 for the serving cells with ServCellIndex 2, 4 and 9 (i.e., C₂, C₄ and C₉ bits are set to 1). The serving cells for a which Cᵢ field is set to 1 (i.e., Serving cells with ServCellIndex 2, 4 and 9) and the PCell are indexed sequentially starting with the PCell and followed by the other serving cells in ascending order of ServCellIndex i. Based on this indexing, the index of the PCell is 0, the index of the serving cell with ServCellIndex 2 is 1, the index of the serving cell with ServCellIndex 4 is 2, and the index of the serving cell with ServCellIndex 9 is 3. The total number of Serving Cells (i.e., SCells/Serving Cells for which a Cᵢ field is set to 1 and the PCell) is 4, as the Cᵢ bit is set to 1 for 3 serving cells and including the PCell the total number of serving cells is 4. In this example, as shown in FIG. 6D, a single octet Eₖ bitmap is included, as the total number of Serving Cells (i.e., SCells/Serving Cells for which a Cᵢ field is set to 1 and the PCell) is greater than 0 and less than 9. E₀ corresponds to PCell, E₁ corresponds to k^{th} (k=1) Serving cell (i.e. Serving Cell with ServCellIndex 2 whose index is 1 as per indexing), E₂ corresponds to corresponds to k^{th} (k=2) Serving cell (i.e. Serving Cell with ServCellIndex 4 whose index is 2 as per indexing), and E₃ corresponds to corresponds to corresponds to k^{th} (k=3) Serving cell (i.e. Serving Cell with ServCellIndex 9 whose index is 3 as per indexing).

In some embodiments, in addition to the Cᵢ and Eₖ bitmaps, the UE may also set one or more of any of the following fields in the MAC CE:

R: Reserved bit, set to 0.

V: This field indicates if the PH value is based on a real transmission or a reference format. For Type 1 PH, the V field set to 0 indicates real transmission on the PUSCH and the V field set to 1 indicates that a PUSCH reference format is used. For Type 2 PH, the V field set to 0 indicates real transmission on the PUCCH and the V field set to 1 indicates that a PUCCH reference format is used. For Type 3 PH, the V field set to 0 indicates real transmission on an SRS and the V field set to 1 indicates that an SRS reference format is used. Furthermore, for Type 1, Type 2, and Type 3 PH, the V field set to 0 indicates the presence of the octet containing the associated P_{CMAX,f,c} field and the MPE field, and the V field set to 1 indicates that the octet containing the associated P_{CMAX,f,c} field and the MPE field is omitted.

Power Headroom (PH): This field indicates the power headroom level.

P: If mpe-Reporting-FR2 is configured and the Serving Cell operates on FR2, the MAC entity sets this field to 0 if the applied P-MPR value, to meet MPE requirements, is less than P-MPR_00 and to 1 otherwise. If mpe-Reporting-FR2 is not configured or the Serving Cell operates on FR1, this field indicates whether power backoff is applied due to power management. The MAC entity sets the P field to 1 if the corresponding P_{CMAX,f,c} field would have had a different value if no power backoff due to power management had been applied.

P_{CMAX,f,c}: If present, this field indicates the P_{CMAX,f,c} for the NR Serving Cell and the P_{CMAX,c} or \tilde{P}_{CMAX,c} for the E-UTRA Serving Cell used for calculation of the preceding PH field.

P_{CMAX,f,c} for assumed PUSCH: If present, this field indicates the P_{CMAX,f,c} for assumed PUSCH for the NR Serving Cell.

MPE: If mpe-Reporting-FR2 is configured, and the Serving Cell operates on FR2, and if the P field is set to 1, this field indicates the applied power backoff to meet MPE requirements. If mpe-Reporting-FR2 is not configured, or if the Serving Cell operates on FR1, or if the P field is set to 0, R bits are present instead.

W: In some embodiments, the octet including the P_{CMAX,f,c} for assumed PUSCH may include this 1 bit field. This field indicates the waveform associated with assumed PUSCH. For example, W can be set to 0 for DFT-S-OFDM and set to 1 for CP-OFDM. Alternately, W can be set to 1 for DFT-S-OFDM and set to 0 for CP-OFDM. In some embodiments, W may not be included.

If actual PUSCH transmission is with a DFT-S-OFDM waveform, the UE computes power headroom information of an assumed PUSCH with a CP-OFDM waveform. If actual PUSCH transmission is with a CP-OFDM waveform, the UE computes power headroom information of an assumed PUSCH with a DFT-S-OFDM waveform. The power headroom information of an assumed PUSCH is the P_{CMAX,f,c} for assumed PUSCH.

The UE obtains P_{CMAX,f,c} for assumed PUSCH and P_{CMAX,f,c} for actual PUSCH transmission as follows:

If the MAC entity has UL resources allocated for a new transmission the MAC entity shall:
1> if at least one PHR has been triggered and not cancelled; and
1> if the allocated UL resources can accommodate the MAC CE for PHR which the MAC entity is configured to transmit, plus its subheader, as a result of LCP:
   2> if multiplePHR with value true is configured:
      3> for each activated Serving Cell with configured uplink associated with any MAC entity of which the active DL BWP is not dormant BWP; and
      3> for each activated Serving Cell with configured uplink associated with E-UTRA MAC entity:
         4> if this MAC entity is configured with phr-AssumedPUSCH-Reporting;
         5> if this MAC entity has UL resources allocated for transmission on this Serving Cell; or
         5> if the other MAC entity, if configured, has UL resources allocated for transmission on this Serving Cell and phr-ModeOtherCG is set to real by upper layers:
         6> if dynamicTransformPrecoderFieldPresenceDCI-0-1-r18 or dynamicTransformPrecoderFieldPresenceDCI-0-2-r18 is set to enabled in the active BWP of this Serving Cell:
         7> obtain the value for the corresponding P_{CMAX,f,c} field for assumed PUSCH from the physical layer if available, as specified in clause 7.7 of TS 38.213.
         6> obtain the value for the corresponding P_{CMAX,f,c} field from the physical layer.

At step 580, the UE transmits the MAC CE to the gNB.

Although FIG. 5 illustrates one example method for PHR reporting 500, various changes may be made to FIG. 5. For example, while shown as a series of steps, various steps in FIG. 5 could overlap, occur in parallel, occur in a different order, occur any number of times, be omitted, or replaced by other steps.

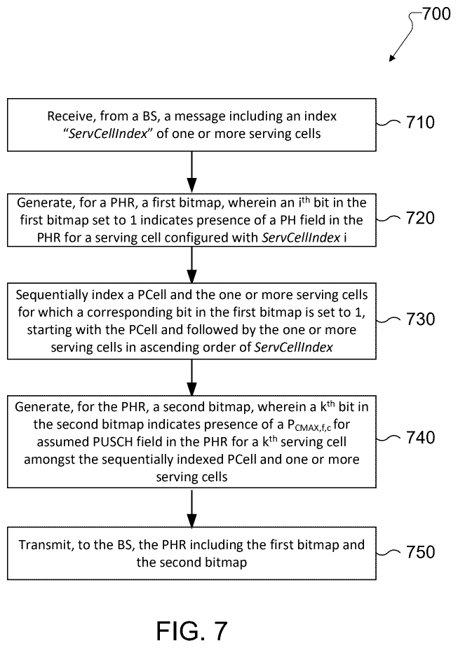

FIG. 7 illustrates an example method for PHR reporting 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a method for PHR reporting could be used without departing from the scope of this disclosure.

In the example of FIG. 7, method 700 begins at step 710. At step 710, a UE (such as UE 116 of FIG. 1) receives, from a BS (such as BS 102 of FIG. 1), a message including an index “ServCellIndex” of one or more serving cells.

At step 720, the UE generates, for a PHR, a first bitmap, wherein an i^{th} bit in the first bitmap set to 1 indicates presence of a PH field in the PHR for a serving cell configured with ServCellIndex i. In some embodiments, the value of i ranges from 1 to 31. In some embodiments the size of the first bit map is 4 octets (i.e., 32 bits), where the first bit is an R bit as shown in FIG. 4B.

At step 730, the UE sequentially indexes the ‘one or more serving cells for which a corresponding bit in the first bitmap is set to 1’ and a PCell, starting with the PCell and followed by the one or more serving cells in ascending order of ServCellIndex.

At step 740, the UE generates, for the PHR, a second bitmap, wherein a k^{th} bit in the second bitmap indicates presence of a P_{CMAX,f,c} for assumed PUSCH field in the PHR for a k^{th} serving cell amongst the sequentially indexed PCell and one or more serving cells.

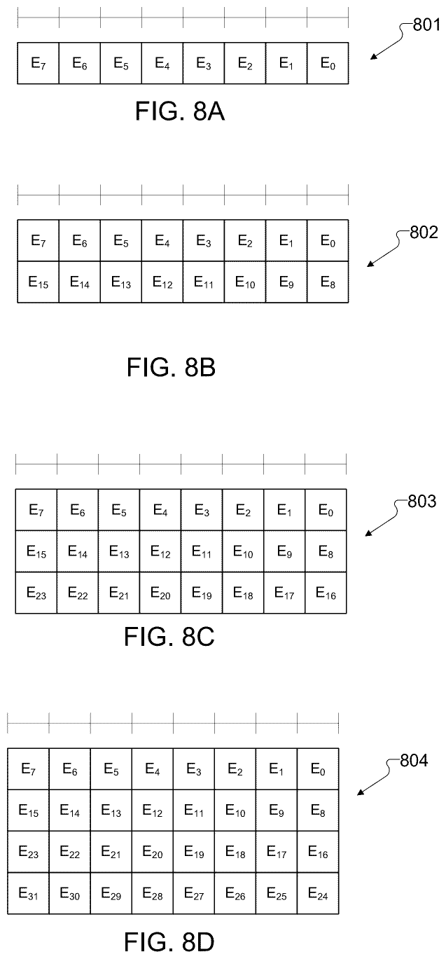

In some embodiments, when a total number of the one or more serving cells for which a corresponding bit in the first bitmap is set to 1 and the PCell is greater than zero and less than nine, the UE generates the second bitmap with a length equal to one octet. For example, the second bitmap may be similar to bitmap 801 as shown in FIG. 8A.

FIGS. 8A-8D illustrate example bitmaps 801-804 for a PHR MAC CE format according to embodiments of the present disclosure. The embodiment of bitmaps for a PHR MAC CE format of FIGS. 8A-8D are for illustration only. Different embodiments of bitmaps for a PHR MAC CE format could be used without departing from the scope of this disclosure.

Although FIGS. 8A-8D illustrates example bitmaps 801-804 for a PHR MAC CE format, various changes may be made to FIGS. 8A-8D. For example, various changes to the size of the bitmaps, etc. could be made according to particular needs.

In some embodiments, when a total number of the one or more serving cells for which a corresponding bit in the first bitmap is set to 1 and the PCell is greater than eight and less than seventeen, the UE generates the second bitmap with a length equal to two octets. For example, the second bitmap may be similar to bitmap 802 as shown in FIG. 8B.

In some embodiments, when a total number of the one or more serving cells for which a corresponding bit in the first bitmap is set to 1 and the PCell is greater than sixteen and less than twenty-five, the UE generates the second bitmap with a length equal to three octets. For example, the second bitmap may be similar to bitmap 803 as shown in FIG. 8C.

In some embodiments, when a total number of the one or more serving cells for which a corresponding bit in the first bitmap is set to 1 and the PCell is greater than twenty-four, the UE generates the second bitmap with a length equal to four octets. For example, the second bitmap may be similar to bitmap 804 as shown in FIG. 8D.

In some embodiments, the UE sets the k^{th} bit in the second bitmap to 1 when the P_{CMAX,f,c} for assumed PUSCH field for the k^{th} serving cell is included in the PHR. Otherwise, the UE sets the k^{th} bit in the second bitmap to 0.

In some embodiments, the UE incudes the P_{CMAX,f,c} for assumed PUSCH field for the k^{th} serving cell when a parameter “phr-AssumedPUSCH-Reporting” is configured for the k^{th} serving cell and at least one of a parameter “dynamicTransformPrecoderFieldPresenceDCI-0-1” or a parameter “dynamicTransformPrecoderFieldPresenceDCI-0-2” is configured in a configuration of active bandwidth part (BWP) of the k^{th} serving cell.

At step 750, the UE transmits, to the BS, the PHR including the first bitmap and the second bitmap.

Although FIG. 7 illustrates one example method for PHR reporting 700, various changes may be made to FIG. 7. For example, while shown as a series of steps, various steps in FIG. 7 could overlap, occur in parallel, occur in a different order, occur any number of times, be omitted, or replaced by other steps.

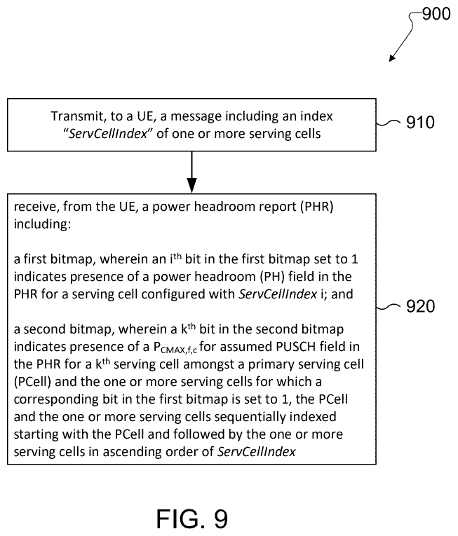

FIG. 9 illustrates an example method for PHR reporting 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method for PHR reporting could be used without departing from the scope of this disclosure.

In the example of FIG. 9, method 900 begins at step 910. At step 910, a BS (such as BS 102 of FIG. 1) transmits to a UE (such as UE 116 of FIG. 1), a message including an index “ServCellIndex” of one or more serving cells.

At step 920, the BS receives from the UE a PHR. The PHR includes a first bitmap, wherein an i^{th} bit in the first bitmap set to 1 indicates presence of a PH field in the PHR for a serving cell configured with ServCellIndex i, and a second bitmap, wherein a k^{th} bit in the second bitmap indicates presence of a P_{CMAX,f,c} for assumed PUSCH field in the PHR for a k^{th} serving cell amongst a primary serving cell (PCell) and the ‘one or more serving cells for which a corresponding bit in the first bitmap is set to 1’, the PCell and the ‘one or more serving cells for which a corresponding bit in the first bitmap is set to l’ are sequentially indexed starting with the PCell and followed by the ‘one or more serving cells for which a corresponding bit in the first bitmap is set to 1’ in ascending order of ServCellIndex.

In some embodiments, when a total number of the one or more serving cells for which a corresponding bit in the first bitmap is set to 1 and the PCell is greater than zero and less than nine, the second bitmap has a length equal to one octet. For example, the second bitmap may be similar as shown in FIG. 8A.

In some embodiments, when a total number of the one or more serving cells for which a corresponding bit in the first bitmap is set to 1 and the PCell is greater than eight and less than seventeen, the second bitmap has a length equal to two octets. For example, the second bitmap may be similar as shown in FIG. 8B.

In some embodiments, when a total number of the one or more serving cells for which a corresponding bit in the first bitmap is set to 1 and the PCell is greater than sixteen and less than twenty-five, the second bitmap has a length equal to three octets. For example, the second bitmap may be similar as shown in FIG. 8C.

In some embodiments, when a total number of the one or more serving cells for which a corresponding bit in the first bitmap is set to 1 and the PCell is greater than twenty-four, the second bitmap has a length equal to four octets. For example, the second bitmap may be similar as shown in FIG. 8D.

In some embodiments, the k^{th} bit in the second bitmap is set to 1 when the P_{CMAX,f,c} for assumed PUSCH field for the k^{th} serving cell is included in the PHR. Otherwise, the k^{th} bit in the second bitmap is set to 0.

Although FIG. 9 illustrates one example method for PHR reporting 900, various changes may be made to FIG. 8. For example, while shown as a series of steps, various steps in FIG. 9 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a base station (BS), a message including an index “ServCellIndex” of one or more serving cells; and
a processor operably coupled to the transceiver, the processor configured to:
generate, for a power headroom report (PHR), a first bitmap, wherein an i^{th} bit in the first bitmap set to 1 indicates presence of a power headroom (PH) field in the PHR for a serving cell configured with ServCellIndex i;
sequentially index the one or more serving cells for which a corresponding bit in the first bitmap is set to 1 and a primary serving cell (PCell), starting with the PCell and followed by the one or more serving cells in ascending order of ServCellIndex; and
generate, for the PHR, a second bitmap, wherein a k^{th} bit in the second bitmap indicates presence of a P_{CMAX,f,c} for assumed PUSCH field in the PHR for a k^{th} serving cell amongst the sequentially indexed PCell and one or more serving cells,
wherein the transceiver is further configured to transmit, to the BS, the PHR including the first bitmap and the second bitmap.

2. The UE of claim 1, wherein to generate the second bitmap, the processor is further configured to, when a total number of the one or more serving cells for which a corresponding bit in the first bitmap is set to 1 and the PCell is greater than zero and less than nine, generate the second bitmap with a length equal to one octet.

3. The UE of claim 1, wherein to generate the second bitmap, the processor is further configured to, when a total number of the one or more serving cells for which a corresponding bit in the first bitmap is set to 1 and the PCell is greater than eight and less than seventeen, generate the second bitmap with a length equal to two octets.

4. The UE of claim 1, wherein to generate the second bitmap, the processor is further configured to, when a total number of the one or more serving cells for which a corresponding bit in the first bitmap is set to 1 and the PCell is greater than sixteen and less than twenty-five, generate the second bitmap with a length equal to three octets.

5. The UE of claim 1, wherein to generate the second bitmap, the processor is further configured to, when a total number of the one or more serving cells for which a corresponding bit in the first bitmap is set to 1 and the PCell is greater than twenty-four, generate the second bitmap with a length equal to four octets.

6. The UE of claim 1, wherein to generate the second bitmap, the processor is further configured to:
set the k^{th} bit in the second bitmap to 1 when the P_{CMAX,f,c} for assumed PUSCH field for the k^{th} serving cell is included in the PHR; and
otherwise, set the k^{th} bit in the second bitmap to 0.

7. The UE of claim 6, wherein the processor is further configured to include the P_{CMAX,f,c} for assumed PUSCH field for the k^{th} serving cell when a parameter “phr-AssumedPUSCH-Reporting” is configured for the k^{th} serving cell and at least one of a parameter “dynamicTransformPrecoderFieldPresenceDCI-0-1” or a parameter “dynamicTransformPrecoderFieldPresenceDCI-0-2” is configured in a configuration of active bandwidth part (BWP) of the k^{th} serving cell.

8. A base station (BS) comprising:
a processor; and
a transceiver operatively coupled to the processor, the transceiver configured to:
transmit, to a user equipment (UE), a message including an index “ServCellIndex” of one or more serving cells; and
receive, from the UE, a power headroom report (PHR) including:
a first bitmap, wherein an i^{th} bit in the first bitmap set to 1 indicates presence of a power headroom (PH) field in the PHR for a serving cell configured with ServCellIndex i; and
a second bitmap, wherein a k^{th} bit in the second bitmap indicates presence of a P_{CMAX,f,c} for assumed PUSCH field in the PHR for a k^{th} serving cell amongst a primary serving cell (PCell) and the one or more serving cells for which a corresponding bit in the first bitmap is set to 1, the PCell and the one or more serving cells sequentially indexed starting with the PCell and followed by the one or more serving cells in ascending order of ServCellIndex.

9. The BS of claim 8, wherein when a total number of the one or more serving cells for which a corresponding bit in the first bitmap is set to 1 and the PCell is greater than zero and less than nine, the second bitmap has a length equal to one octet.

10. The BS of claim 8, wherein when a total number of the one or more serving cells for which a corresponding bit in the first bitmap is set to 1 and the PCell is greater than eight and less than seventeen, the second bitmap has a length equal to two octets.

11. The BS of claim 8, wherein when a total number of the one or more serving cells for which a corresponding bit in the first bitmap is set to 1 and the PCell is greater than sixteen and less than twenty-five, the second bitmap has a length equal to three octets.

12. The BS of claim 8, wherein when a total number of the one or more serving cells for which a corresponding bit in the first bitmap is set to 1 and the PCell is greater than twenty-four, the second bitmap has a length equal to four octets.

13. The BS of claim 8, wherein:
the k^{th} bit in the second bitmap is set to 1 when the P_{CMAX,f,c} for assumed PUSCH field for the k^{th} serving cell is included in the PHR; and
otherwise, the k^{th} bit in the second bitmap is set to 0.

14. A method of operating a user equipment (UE), the method comprising:
receiving, from a base station (BS), a message including an index “ServCellIndex” of one or more serving cells;
generating, for a power headroom report (PHR), a first bitmap, wherein an i^{th} bit in the first bitmap set to 1 indicates presence of a power headroom (PH) field in the PHR for a serving cell configured with ServCellIndex i;
sequentially indexing the one or more serving cells for which a corresponding bit in the first bitmap is set to 1 and a primary serving cell (PCell), starting with the PCell and followed by the one or more serving cells in ascending order of ServCellIndex;
generating, for the PHR, a second bitmap, wherein a k^{th} bit in the second bitmap indicates presence of a P_{CMAX,f,c} for assumed PUSCH field in the PHR for a k^{th} serving cell amongst the sequentially indexed PCell and one or more serving cells; and
transmitting, to the BS, the PHR including the first bitmap and the second bitmap.

15. The method of claim 14, further comprising, when a total number of the one or more serving cells for which a corresponding bit in the first bitmap is set to 1 and the PCell is greater than zero and less than nine, generating the second bitmap with a length equal to one octet.

16. The method of claim 14, further comprising, when a total number of the one or more serving cells for which a corresponding bit in the first bitmap is set to 1 and the PCell is greater than eight and less than seventeen, generating the second bitmap with a length equal to two octets.

17. The method of claim 14, further comprising, when a total number of the one or more serving cells for which a corresponding bit in the first bitmap is set to 1 and the PCell is greater than sixteen and less than twenty-five, generating the second bitmap with a length equal to three octets.

18. The method of claim 14, further comprising, when a total number of the one or more serving cells for which a corresponding bit in the first bitmap is set to 1 and the PCell is greater than twenty-four, generating the second bitmap with a length equal to four octets.

19. The method of claim 14, further comprising:
setting the k^{th} bit in the second bitmap to 1 when the P_{CMAX,f,c} for assumed PUSCH field for the k^{th} serving cell is included in the PHR; and
otherwise, setting the k^{th} bit in the second bitmap to 0.

20. The method of claim 19, further comprising including the P_{CMAX,f,c} for assumed PUSCH field for the k^{th} serving cell when a parameter “phr-AssumedPUSCH-Reporting” is configured for the k^{th} serving cell and at least one of a parameter “dynamicTransformPrecoderFieldPresenceDCI-0-1” or a parameter “dynamicTransformPrecoderFieldPresenceDCI-0-2” is configured in a configuration of active bandwidth part (BWP) of the k^{th} serving cell.
